(19) United States
(12) Patent Application Publication
(10) Pub. No.: US 2024/0248660 A1
(43) Pub. Date: Jul. 25, 2024

(54) METHOD FOR PRINTING A DOCUMENT ON AN ELECTRONIC PAPER WITH A VIRTUAL PRINTER, AND VIRTUAL PRINTER SYSTEM

(71) Applicant: Ekko GmbH, Witten (DE)

(72) Inventors: Rouven Falkewitz, Witten (DE); Benny Philip Lehmann, Witten (DE)

(21) Appl. No.: 18/412,792

(22) Filed: Jan. 15, 2024

(30) Foreign Application Priority Data
Jan. 24, 2023 (EP) 23153138.5

(51) Int. Cl. G06F 3/12; G06K 15/02

(52) U.S. Cl. CPC G06F 3/1243; G06F 3/1219; G06F 3/1285; G06K 15/021

(57) ABSTRACT

A method for printing a document on an electronic paper with a virtual printer, the method comprising: selecting a document to be printed; creating a print job for printing the document to be printed; creating, based on the print job, a data set representing the document to be printed in a format interpretable by the electronic paper with the virtual printer; transmitting the data set to the electronic paper; and displaying the document to be printed on the electronic paper based on the transmitted data set, so that the electronic paper is printed with the document to be printed by the virtual printer, wherein preferably the print job comprises a page description language or a printer language.

### CROSS-REFERENCE TO RELATED APPLICATIONS

This application claims the benefit and priority of European Patent application Ser. No. 23153138.5 filed Jan. 24, 2023. The entire disclosure of the above application is incorporated herein by reference.

### BACKGROUND OF THE INVENTION

### Technical Field

The invention relates to a method for printing a document on an electronic paper using a virtual printer, and a virtual printer system.

### Discussion

In the production or manufacture of a wide variety of goods, tickets or tickets, sequence tickets, transport lists, accompanying cards or the like are used, for example in order to comply with a sequence of assembly steps or manufacturing steps. The tickets are physically printed on paper and document which work steps a product has already gone through or which work steps it still has to gone through. Once a work step has been completed, this is usually either noted on the ticket or a new ticket is (physically) printed.

Likewise, for example in logistics, shelves are filled in the sequence in which the contents of the shelves have to be installed on the assembly line. A short-lived paper ticket, which indicates which material is currently located in the shelf, is included in each of these shelves. The paper tickets have to be adapted or changed correspondingly frequently or at least regularly, for which purpose a new ticket has to be physically printed on paper.

These (physical) updates of the tickets require a comparatively high outlay. In addition, new printer paper is required for each update.

It is therefore the aspect of the present invention to overcome these disadvantages. The present invention enables a simple, uncomplicated, flexible and resource-saving printing of corresponding tickets. However, the invention does not have to be limited to such tickets. According to the invention, it is provided to print the same documents not physically on paper, but electronically on electronic paper. Thus, the same print job as in physical printing can be used, so that no adaptations are necessary on the user side. The electronic paper can be printable multiple times, so that updates of the tickets can be carried out simply, quickly and in a resource-saving manner. Suitable electronic paper is marketed, for example, by SoluM or PDi Digital.

### SUMMARY

The aspect of the invention is achieved by a method according to claim 1 and a virtual printer system according to claim 9. The dependent claims each relate to advantageous embodiments.

A first aspect of the invention relates to a method for printing a document on an electronic paper with a virtual printer, the method comprising the steps of:
a) selecting a document to be printed;
b) creating a print job for printing the document to be printed;
c) creating, based on the print job, a data set representing the document to be printed in a format interpretable by the electronic paper with the virtual printer;
d) transmitting the data set to the electronic paper; and
e) displaying the document to be printed on the electronic paper based on the transmitted data set, so that the electronic paper is printed with the document to be printed by the virtual printer.

It can be provided that the print job can comprise a page description language or a printer language. In some embodiments, it can be provided that, when creating the print job, the document can be translated and/or converted into a or the page description language or printer language. In some embodiments, it can be provided that, when creating the print job, a file can be created in a or the page description language or printer language. Printing the electronic paper can mean in particular that the document is displayed on the electronic paper. The electronic paper can be printed by displaying the document to be printed with the document to be printed by the virtual printer. The electronic paper can thereby be printed electronically. By carrying out at least one, several or all of steps a)-e), in particular steps c)-e), the electronic paper can be printed by the virtual printer.

The virtual printer can thus print a document corresponding to a physical printer. The virtual printer can be configured to receive and/or process the same print job as a physical printer. If, for example, the print job is transmitted to a physical printer, for example an inkjet printer or laser printer, the physical printer can print the document on a physical paper. If, for example, the print job, e.g. the same print job, is transmitted to the virtual printer, the document can be printed electronically on the electronic paper. Thus, a good flexibility can result, since users, users or also computer programs who want to print a document can use the same print job as for the physical document. It can thus be enabled that no changes have to be made on the user side in order to print the electronic paper or to print electronically, but that all steps and adaptations necessary for this are carried out by the virtual printer. Due to the fact that the virtual printer can process the print job, a simple and uncomplicated printing of the electronic paper results.

The data set representing the document to be printed can be or comprise an expression. The expression can be a virtual expression. The data set and/or the expression can be or comprise a file. The document can comprise, for example, one or more texts and/or one or more images or graphics.

The electronic paper can have a suitable display, for example an e-ink display or e-paper display.

The method can be or comprise a computer-implemented method. At least one, several or all of the steps of the method can be at least partially or completely computer-implemented. The virtual printer can be and/or comprise a computer unit. Alternatively or additionally, it can be provided that the virtual printer can be part of a computer unit. The virtual printer, the computer unit and/or the computer unit can be or comprise a desktop PC, a workstation, a mobile device such as a laptop or smartphone, a server, an integrated circuit, a microcontroller or the like.

The print job can comprise and/or be a data format dvi (device independent file format), ps (PostScript), pdf (portable document format), xps (xml paper specification), svg (scalable vector graphics), and/or pcl (printer command language).

The virtual printer can perform a dithering during and/or after the creation of the data set. Depending on the type and/or type of the electronic paper, gray levels can thus be displayed and/or approximated on the electronic paper, and/or be printed.

The virtual printer can substantially correspond to a network printer. Alternatively or additionally, the virtual printer can comprise or be a network printer. It can be provided that the print job can be created by a peripheral device. The peripheral device can be connected to a or the virtual printer for data exchange. In some embodiments, one or more peripheral devices can be provided. It can be provided that one or more peripheral devices can transmit one or more print jobs, and/or one or more documents to be printed to the virtual printer. Thus, in some embodiments, a network printer functionality can result. Alternatively or additionally, it can be provided that the print job can be created by the virtual printer. If more than one virtual printer is provided, each virtual printer can be connected to an electronic paper or a plurality of electronic papers.

The peripheral device can be or comprise a computer device. For example, the peripheral device can be or comprise a desktop PC, a workstation, a mobile device such as a laptop or smartphone, a server, an integrated circuit, a microcontroller or the like.

The data set can be transmitted to a plurality of electronic papers during the transmission of the data set. The document to be printed can be displayed on each of the plurality of electronic papers during the display of the document to be printed. In some embodiments, the print job can contain information on which electronic paper or on which electronic papers the document is to be printed.

In some embodiments, a separate print job and/or data set can be created for each of the plurality of electronic papers. The data set can be transmitted in a format interpretable by the respective electronic paper during the transmission of the data set to a respective electronic paper in some embodiments.

The document to be printed can have a plurality of pages, wherein the electronic paper can display a page of the plurality of pages during the display of the document to be printed and change the displayed page in response to a control command.

The document to be printed can differ from a document already printed on the electronic paper during the selection of the document to be printed, so that the electronic paper can be printed again. Alternatively or additionally, it can generally be provided to print and/or “overprint” an electronic paper again. To this end, it can be provided to carry out and/or repeat the method again, in some embodiments multiple times.

A further aspect of the invention relates to a virtual printer system, comprising at least one electronic paper and at least one virtual printer, wherein the electronic paper is connected to the virtual printer for data exchange, and wherein the virtual printer is configured to print the electronic paper with a document to be printed using a method according to any one described above.

The virtual printer system can comprise physical components, units and/or entities. The virtual printer system can comprise one or more computer units or the like.

The document to be printed can be or comprise an accompanying slip, a ticket, a transport list or a sequence protocol. In principle, however, the method and/or the virtual printer system is suitable for printing any type of documents. In particular, the method and/or the virtual printer system can be suitable for printing each document physically printable using a conventional printer on electronic paper.

The electronic paper can be connected to the virtual printer via narrowband IOT. The connection between electronic paper and virtual printer is, however, not restricted thereto. The connection can comprise, for example, a low-power wide-area network or a corresponding protocol. The connection can be wireless. The connection can comprise Bluetooth, Zigbee, WLAN, LTE, GSM or the like, and/or corresponding protocols. In some embodiments, alternatively or additionally, the connection between electronic paper and virtual printer can be wired.

The virtual printer can be connected to one or more peripheral devices via narrowband IOT. The connection between peripheral device and virtual printer is, however, not restricted thereto. The connection can comprise, for example, a low-power wide-area network or a corresponding protocol. The connection can be wireless. The connection can comprise Bluetooth, Zigbee, WLAN, LTE, GSM or the like, and/or corresponding protocols. In some embodiments, alternatively or additionally, the connection between peripheral device and virtual printer can be wired.

The virtual printer system can comprise a plurality of virtual printers which can be connected to the at least one electronic paper for data exchange. The print job and/or data set can be created by each of the virtual printers in some embodiments.

The virtual printer system can comprise at least one peripheral device, wherein the peripheral device can be connected to the virtual printer for data exchange. The peripheral device can be configured to transmit a document to be printed and/or a print job to the virtual printer.

The virtual printer system can comprise a printer station having a provision location for providing electronic paper. The printer station can comprise a printer unit for printing electronic paper provided at the provision location, wherein the printer unit can be connected to the virtual printer for data exchange.

A plurality of electronic papers can be stacked on top of one another to form a stack at or at the provision location. The printer station can be configured and/or arranged such that one or more electronic papers of the stack can be printed.

### BRIEF DESCRIPTION OF THE DRAWINGS

The invention is explained further with reference to the following figures. In the figures:

FIG. 1 an exemplary embodiment of a virtual printer system according to the invention;

FIG. 2 a further exemplary embodiment of a virtual printer system according to the invention;

FIG. 3 an unprinted electronic paper and a printed electronic paper;

FIG. 4 yet a further exemplary embodiment of a virtual printer system according to the invention; and

FIG. 5 yet another exemplary embodiment of a virtual printer system according to the invention.

### DESCRIPTION OF THE PREFERRED EMBODIMENTS OF THE INVENTION

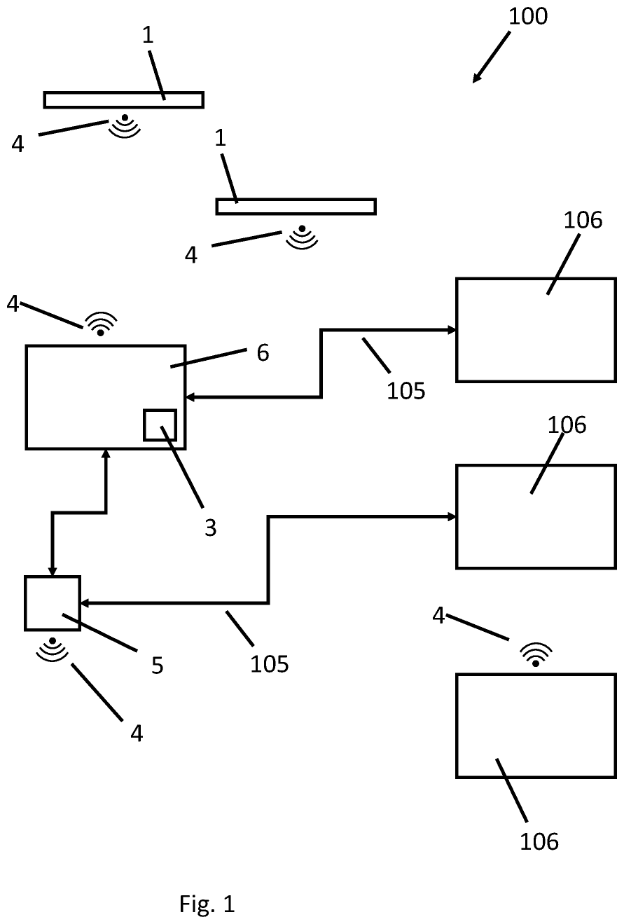

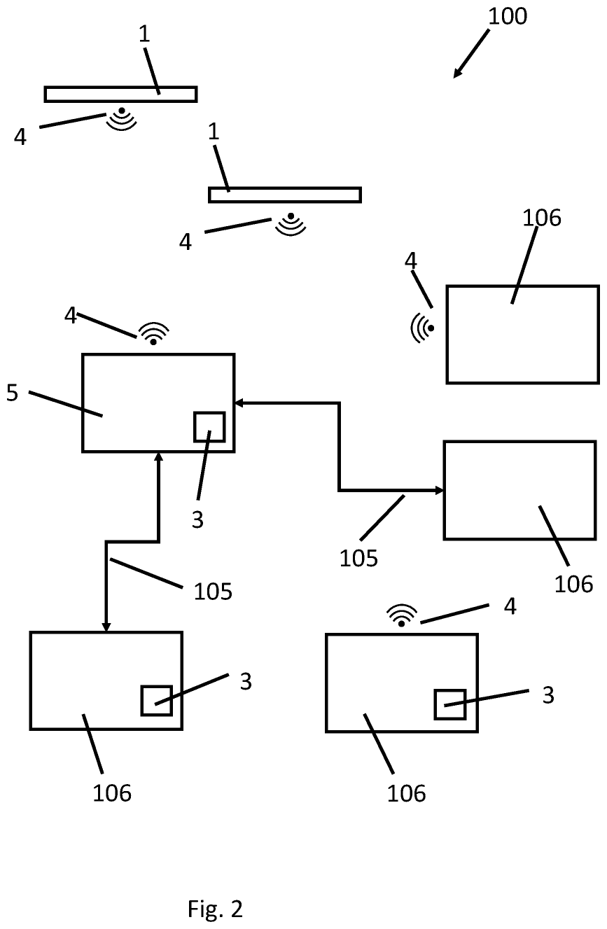

FIGS. 1 and 2 show exemplary embodiments of a virtual printer system 100 according to the invention. The exemplary embodiments shown and/or described in FIGS. 1 and/or 2 can have one, more or all features of one or more other exemplary embodiments shown and/or described. The virtual printer system 100 comprises an electronic paper 1 and a virtual printer 3. In some embodiments, the virtual printer system 100 can comprise more than one electronic paper 1 and/or more than one virtual printer 3.

The virtual printer 3 can be computer-implemented. The virtual printer 3 can be implemented, set up and/or installed and/or run on a computer device 6, a communication unit 5 and/or a peripheral device 106. The virtual printer 3 can be or form an entity. The computer device 6 can be or comprise a server, for example a cloud server. It can be provided that the computer device 6 can be set up and/or arranged on site or locally. Alternatively or additionally, the computer device 6 can be or comprise a desktop PC, a workstation, a mobile device such as a laptop or smartphone, a server, an integrated circuit, a microcontroller or the like. The virtual printer 3 can be a network printer, correspond to a network printer and/or provide or have a function of a network printer. One, more or all of the peripheral device 106, virtual printer 3, computer device and/or communication unit 5 can be connected via one or more networks.

Alternatively or additionally, the virtual printer 3 can be or comprise a computer unit, for example a or the computer device 6. The virtual printer 3 can be part of a computer unit. The virtual printer 3, the computer unit and/or the computer unit can be or comprise a desktop PC, a workstation, a mobile device such as a laptop or smartphone, a server, an integrated circuit, a microcontroller or the like. Virtual printer 3 and electronic paper 1 can be connected to one another for data exchange and/or can exchange data with one another, for example via a communication interface and/or communication unit 5. For example, a radio connection 4 can be provided between virtual printer 3 and electronic paper 1.

One or the radio connection 4 can be or comprise a wireless connection. The radio connection 4 can comprise narrowband IoT (narrowband Internet of Things), LTE, GSM, Bluetooth, Zigbee, WLAN or the like.

The virtual printer 3 can be configured to create, based on a print job, a data set which is interpretable by the electronic paper 1 and/or has a format interpretable by the electronic paper 1. The print job can be a command to print out a document 2 to be printed. The print job can comprise a page description language and/or a printer language. The print job can be present electronically and/or as a file and/or computer command and/or comprise such.

The print job can contain and/or comprise information relating to the document 2 to be printed. The print job can comprise information relating to the pages of the document 2 to be printed out, the color, size and/or cut-outs, page format, page ratio, zoom factor such as enlargements or reductions, or the like. The print job can contain and/or specify information on which electronic paper 1 the document 2 is to be printed. It can also be provided to print the same and/or identical document 2 on more than one electronic paper 1. The print job can be configured and/or executed such that a physical printer, e.g. an inkjet printer and/or a laser printer, can print the document 2 on a physical paper with reference to the print job. In some embodiments, the print job can comprise or contain data in the data format dvi (device independent file format). Alternatively or additionally, the print job can comprise or contain data in the data format ps (PostScript). Alternatively or additionally, the print job can comprise or contain data in the data format xps (xml paper specification). Alternatively or additionally, the print job can comprise or contain data in the data format svg (scalable vector graphics). Alternatively or additionally, the print job can comprise or contain data in the data format pcl (printer command language).

The interpretable format can be and/or have a suitable data format. The electronic paper 1 is configured to display a document to be printed corresponding to the data set when the data set is or is transmitted to the electronic paper in the interpretable format. Thus, the electronic paper 1 can be or will be printed with the document 2.

The method according to the preferred embodiment of the invention for printing a document 2 on an electronic paper can firstly comprise selecting a document 2 to be printed. The document 2 to be printed can be selected, for example, automatically and/or in a computer-controlled manner. In some embodiments, alternatively or additionally, it can be provided that a user selects and/or can select the document 2 to be printed. A print job can then be or will be created for the document 2 to be printed. In some embodiments, the document 2 to be printed can be selected by or using the virtual printer 3. The virtual printer 3 can comprise, for example, a computer unit, and/or a computer unit can comprise the virtual printer 3, so that the document 2 to be printed can be or will be selected by or using the computer unit and/or the computer unit. Alternatively or additionally, one or more peripheral devices 106 can be provided. The document 2 to be printed can be or will be selected by or using the peripheral device 106.

A print job can then be or will be created. In some embodiments, the print job can be or will be created by or using the virtual printer 3, and/or e.g. the computer unit and/or the computer unit. Alternatively or additionally, it can be provided that the print job can be or will be created by or using the peripheral device 106. If the print job has been or has been created by or using the peripheral device 106, it can be provided to transmit the print job to the virtual printer 3.

The virtual printer 3 can then create a data set representing the document 2 to be printed based on and/or with reference to the print job. The data set can comprise or contain control commands and/or information relating to the document 2 to be printed. The data set can be configured and/or executed such that the electronic paper 1 can display the document 2 with reference to and/or based on the data set.

The created data set can be or will be transmitted to the electronic paper 1. For example, the virtual printer 3 can have suitable transmission means. The electronic paper 1 can then display the document 2. Thus, the electronic paper 1 can be or will be printed by and/or with the virtual printer 3.

In other words, it can be provided that the virtual printer 3 can have a function corresponding to a physical printer. Thus, the physical printer can be configured to print the document 2 on a physical paper based on the print job, whereas the virtual printer 3 can be configured to print the document 2 electronically on the electronic paper 1 based on the same print job. Thus, a high flexibility can be achieved by the virtual printer system 100 with low adaptations at the same time, since the same print job can be used as for physical printing. Due to the electronic or virtual printing using the virtual printer 3 or the virtual printer system 100, however, the electronic paper 1 can be or will be printed and/or “overprinted” again or multiple times simply and uncomplicated, so that, for example, changes of the print can be carried out simply and uncomplicated.

It can be provided that the print job can be or will be created with or by a user software. The user software can be configured and/or used to open and/or load a or the document 2 to be printed. In some embodiments, a user can select a document 2 to be printed, e.g., using the user software, and then create the print job using a print function of the user software. For example, when using the print function and/or by the print function, several printers can be selectable, of which at least one can be a virtual printer 3. It can be provided that at least one of the selectable printers can be a physical printer. By selecting the printer, it can be or will be selected to which printer the print job can be or will be sent. In some embodiments, alternatively or additionally, a or the user software can automatically and/or independently select a printer, e.g., a or the virtual printer 3, and/or create a print job, e.g., with reference to a predefined logic or programming.

The user software can be installed and/or run on a or the peripheral device 106. The peripheral device 106 can be used to select a or the document 2 to be printed.

The user software can be or comprise, for example, a text processing program, an editor, a graphics or drawing program, a pdf viewer or the like and/or a file viewer. The user software can be or comprise a program which can be suitable and/or configured for printing a document and/or a file, a graphic or drawing, a model or the like.

In some embodiments, the virtual printer system 100 can comprise one or more peripheral devices 106. Peripheral device 106 can be connected to the virtual printer 3 for data exchange and/or can exchange data with the virtual printer 3. In some embodiments, a or the virtual printer 3 can run and/or be set up, installed and/or implemented on a computer device 6. A or the peripheral device 106 can be connected to the computer device 6 via a cable and/or a cable connection 105 and/or a radio connection 4 and/or can exchange data. Alternatively or additionally, a communication unit 5 can be provided, to which a or the peripheral device 106 can be connected via a cable and/or a cable connection 105 and/or a radio connection 4 and/or can exchange data. In some embodiments, the communication unit 5 and the computer device 6 can be set up for data exchange.

It can be provided that the communication unit 5 can forward and/or communicate data received from a peripheral device to the computer device 6. It can be provided that the computer device 6 can comprise the communication unit 5 and/or that the communication unit 5 can be part of the computer device 6. Alternatively or additionally, the communication unit 5 can be or comprise a gateway and/or can serve as a gateway. In some embodiments, the communication unit 5 can be connected to the computer device 6 via a cable connection 105 and/or (not shown in FIGS. 1 and 2) can be connected to the computer device 6 via a radio connection.

The peripheral device 106 can transmit the print job to the communication unit 5 and/or the computer device 6. The print job can comprise data and/or consist of data.

It can be provided that the communication unit 5 can be connected to an electronic paper 1 and/or to more or all electronic papers 1 of the system 100 for data exchange and/or can exchange data. The communication unit 5 can be connected to one, more or all electronic papers 1 via a radio connection 4, for example. In some embodiments, the communication interface 5 can be configured to transmit the data set created by one or the virtual printer 3 to one, more or all of the electronic papers 1.

The communication unit 5 can receive a data set created by the virtual printer 3, for example a virtual printer 4 running, implemented, set up and/or installed on the computer device 6, e.g. a data set representing the document 2 to be printed, and communicate it to one or more electronic papers 1. Alternatively or additionally, the computer device 6 can communicate a data set created by the virtual printer 4 running, implemented, set up and/or installed on the computer device 6, e.g. a data set representing the document 2 to be printed, to one or more electronic papers 1.

In some embodiments, the communication interface 5 can be configured to execute, operate and/or use one or the virtual printer 3. It can be provided that one or the virtual printer 3 can run on the communication unit 5 and/or can be installed, set up and/or implemented. In some embodiments, no computer device 6 can be provided in this case and/or the system 100 cannot comprise a computer device 6. Alternatively or additionally, it can be provided that a virtual printer 3 can run on a or the computer device 6 and/or can be installed, set up and/or implemented, and the virtual printer 3 and/or a further virtual printer 3 can run on the communication unit 5 and/or can be installed, set up and/or implemented.

In some embodiments, at least one peripheral device 106 can be connected to the virtual printer 3 via a cable or a cable connection 105. Alternatively or additionally, it can be provided that at least one peripheral device 106 can be or will be connected to the virtual printer 3 wirelessly, e.g. via a radio connection 4.

A connection and/or a data exchange with a or the virtual printer 3 can comprise that data are or will be communicated and/or transmitted indirectly and/or directly to the virtual printer 3 and/or that the virtual printer 3 can access and/or retrieve the data. For example, a virtual printer 3 can be connected to a peripheral device 106 and/or communication unit 5 if peripheral device 106 and/or communication unit 5 can transmit data to a computer device 6 on which the virtual printer 3 runs and/or is set up, implemented and/or installed, and the virtual printer 3 can retrieve, modify and/or process the transmitted data and/or has access to the data.

A connection and/or a data exchange with a or the virtual printer 3 can comprise that data are or will be communicated and/or transmitted indirectly and/or directly by the virtual printer 3, for example to a peripheral device 106, a communication unit 5 and/or a printer unit 102. For example, a data set created by a virtual printer 3, for example a set up, implemented and/or installed virtual printer 3 running on a computer device 6, can be or will be transmitted with the aid of the computer unit 6 and/or a suitable interface to a peripheral device 106, a communication unit 5 and/or a printer unit 102.

The radio connection 4 can comprise narrowband IoT (narrowband Internet of Things), LTE, GSM, Bluetooth, Zigbee, WLAN or the like.

The peripheral device 106 can be or comprise a computer device. For example, the peripheral device can be or comprise a desktop PC, a workstation, a mobile device such as a laptop or smartphone, a server, an integrated circuit, a microcontroller or the like.

In some embodiments, alternatively or additionally, a peripheral device 106 can comprise a or the virtual printer 3. It can be provided that the peripheral device 106 can execute, operate and/or use one or the virtual printer 3. It can be provided that one or the virtual printer 3 can run on the peripheral device 106 and/or can be installed, set up and/or implemented. In some embodiments, it can be provided that the peripheral device 106 can transmit a data set representing the document 2 to be printed to one, more or all of the electronic papers 1. In some embodiments, peripheral device 106 and electronic paper 1 can be connected to one another via a radio connection 4, for example.

The virtual printer can substantially correspond to a network printer and/or comprise a network printer. One or more peripheral devices 106 can be connected to the virtual printer 3 and/or can be in data exchange with the virtual printer 3 and/or can be set up for data exchange with the virtual printer 3. One, more or each of the peripheral devices 106 can transmit a print job to the virtual printer 3, for example, so that the document 2 can be printed on one or more electronic papers 1.

If the virtual printer system 100 comprises electronic papers 1 of different types and/or types, it can be provided that the data sets respectively transmitted to the respective electronic papers 1 differ. The respective data sets can be configured such that they can be interpreted by the respective electronic paper 1 to which they can be transmitted. In other words, the virtual printer 3 can create data sets respectively configured depending on the respective electronic papers 1 such that the respective electronic papers 1 can display the document 2, and thus can be printed by the virtual printer 3.

If an electronic paper 1 is printed, it can be provided to print the electronic paper 1 again with the same document 2, a modified document 2 and/or another document 2. An already printed electronic paper 1 can be or will be “overprinted”.

The virtual printer system 100 can comprise more than one virtual printer 3. It can be provided that at least two virtual printers 3 are connected to at least one electronic paper 1 and/or can exchange data. It can be provided that at least two virtual printers 3 are connected to the same electronic paper 1. In some embodiments, each virtual printer 3 can be connected to each electronic paper 1 and/or can exchange data. It can be provided that at least two peripheral devices 106 are connected to at least one virtual printer 3. It can be provided that at least two peripheral devices 106 are connected to the same virtual printer 3. In some embodiments, a virtual printer can receive a print job and/or a document 2 to be printed from each peripheral device 106 connected to it. In some embodiments, an electronic paper 1 can receive a data set from each peripheral device 106 connected to it.

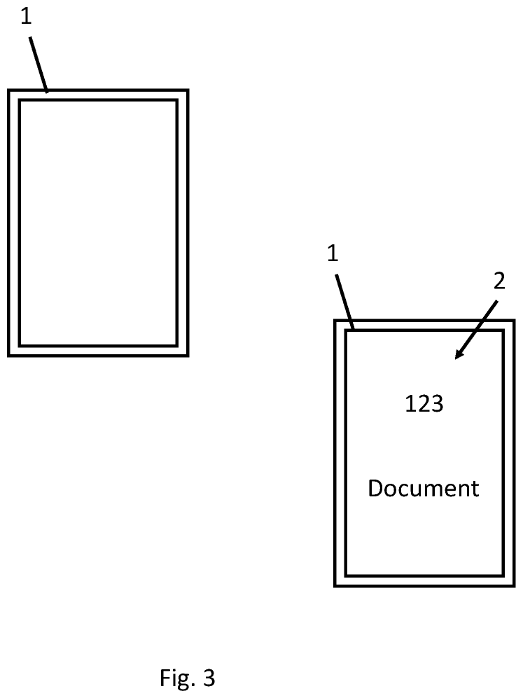

FIG. 3 shows by way of example an unprinted electronic paper 1 (left) and an electronic paper 1 printed with a document 2 (right). The electronic paper 1 can have a suitable display, for example an e-ink display or e-paper display.

In some embodiments, the document 2 can comprise more than one page. Depending on the configuration of the electronic paper 1, the electronic paper 1 can be configured to display more than one page of the document 2. In some embodiments, alternatively or additionally, it can be provided that the electronic paper 1 displays at least one page, and at least one other page is not displayed. In some embodiments, the electronic paper 1 can be configured to change at least one of the displayed pages. For example, a control command can be communicated to the electronic paper 1, in response to which the electronic paper 1 can change at least one of the displayed pages. It can be provided that the document 2 can be scrolled by changing the pages.

In some embodiments, the electronic paper 1 can comprise one or more input fields, touch displays, buttons and/or buttons or the like, via which a user can communicate corresponding control commands to the electronic paper 1. Alternatively or additionally, a corresponding control command can be communicated to the electronic paper 1 by a computer device, for example virtual printer 3, computer unit, peripheral device 106, and/or the like.

In some embodiments, the virtual printer 3 can perform a dithering during and/or after the creation of the data set. Depending on the type and/or type of the electronic paper 1, this can represent a specific set of colors, in some cases exclusively represent a specific set of colors. In this case, gray levels in particular are often not included for some electronic papers 1. By means of the dithering, gray levels in particular can be approximated e.g. by the colors black and white. The printed document 2 can cause a visual impression similar to the original document by means of the dithering. The dithering can be performed in some embodiments before the transmission of the data set to the electronic paper 1. In some embodiments, the dithering can be contained in the data set, and/or the data set can comprise the dithering.

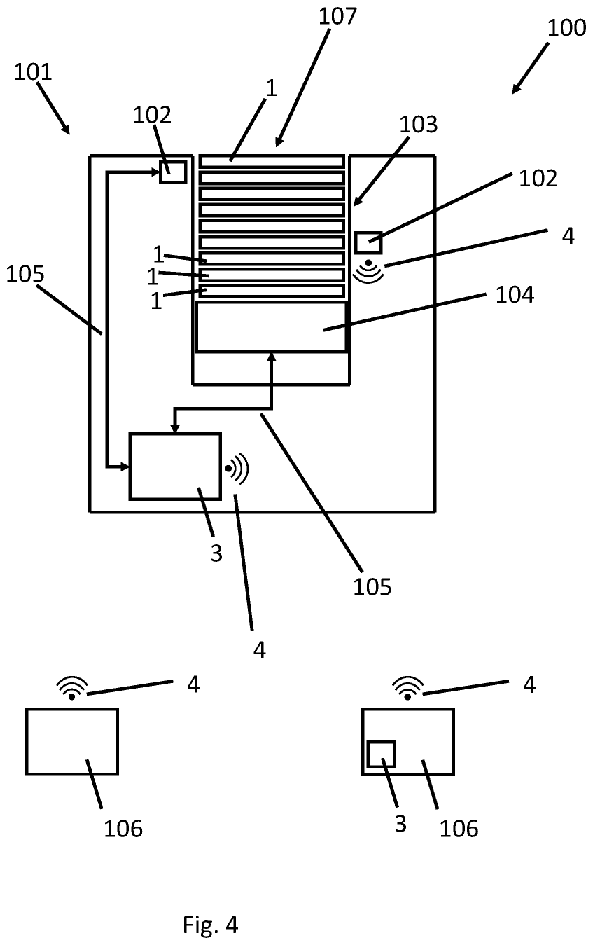

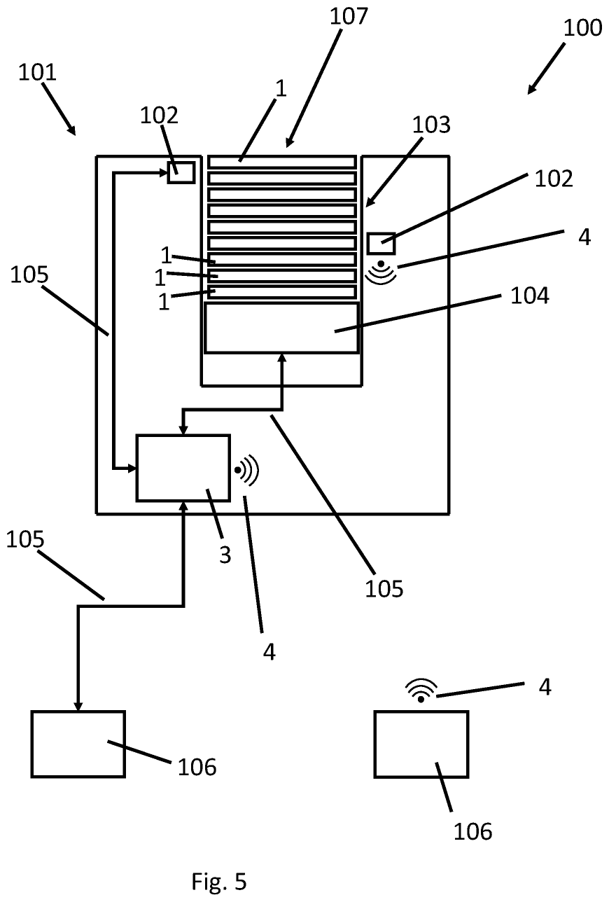

FIGS. 4 and 5 show further exemplary embodiments of a virtual printer system 100 according to the invention. The exemplary embodiments shown and/or described in FIGS. 4 and 5 can have one, more or all features of one or more other exemplary embodiments shown and/or described. The virtual printer system 100 can comprise a printer station 101. The printer station 101 can be configured to provide and/or print electronic paper 1. In some embodiments, the electronic paper 1 can be stacked on top of one another to form a stack 103. The printer station 101 can comprise a virtual printer 3. The printer station 101 can comprise, for example, a computer unit (not shown in FIGS. 4 and 5) which can execute the virtual printer 3 and/or in or with which the virtual printer 3 can be implemented, set up and/or installed and/or can run. The virtual printer 3 can be or form an entity which can be executed by the computer unit and/or can run on the computer unit. In some embodiments, the computer unit can have one, more or all of the features and/or advantages of the computer device 6 described above, and/or can be or comprise a computer device 6 described above. Alternatively or additionally, it can be provided that a or the virtual printer 3 can exchange data with the printer station 101, for example via a radio connection 4 and/or a cable connection 105 (not shown in the figures). The radio connection 4 can be or comprise a wireless connection, and/or can comprise narrowband IoT (narrowband Internet of Things), LTE, GSM, Bluetooth, Zigbee, WLAN or the like.

The printer station 101 can comprise a printer unit 102. The printer unit 102 can be connected to the virtual printer 3 for data exchange and/or can exchange data, for example via a radio connection 4 and/or a cable connection 105. The radio connection 4 can be or comprise a wireless connection, and/or can comprise narrowband IoT (narrowband Internet of Things), LTE, GSM, Bluetooth, Zigbee, WLAN or the like. The printer unit 102 can be configured to transmit a or the data set created by the virtual printer 3 to one or more electronic papers 1. In some embodiments, a virtual printer 3, for example a or the virtual printer 3 of the printer station 101, can comprise the printer unit 102, and/or the printer unit 102 can be a part of a or the virtual printer 3.

In some embodiments, alternatively or additionally, a or the peripheral device 106 can comprise a virtual printer 3, and/or a or the virtual printer 3 can be installed, implemented and/or set up and/or run on the peripheral device 106. The peripheral device 106 can comprise a data set created by the virtual printer 3 to the printer station 101 and/or the printer unit 102. It can be provided that the printer station 101 can comprise a corresponding communication interface for data exchange with the peripheral device 106 and/or a communication device (not shown in the figures).

The printer unit 102 can transmit the data set wirelessly to the electronic paper 1, for example via a radio connection 4. The radio connection 4 can comprise narrowband IoT (narrowband Internet of Things), LTE, GSM, Bluetooth, Zigbee, WLAN or the like. The printer unit 102 can be arranged suitably in or on the printer station 101. If, for example, a plurality of electronic papers 1 are stacked on top of one another to form a stack 103, the printer unit 102 can be arranged such that it can exchange data with one, more or all electronic papers 1 of the stack 103. In some embodiments, it can be provided that the uppermost electronic paper 1 of the stack 103 can be printed. One or more of the electronic papers 1 can be provided at a provision location 107 of the printer station 101. In some embodiments, for example if a plurality of electronic papers 1 are stacked to form a stack 103, the provision location 107 can correspond to the position of the uppermost electronic paper 1 in the stack 103. If, for example, the uppermost electronic paper 1 of the stack 103 is printed, for example by the virtual printer 3 and/or the printer unit 102, the printed electronic paper 1 can be removed at the provision location 107. In some embodiments, the printer unit 102 can have one, more or all features and/or advantages of a communication unit 5 described above, and/or can be or comprise a communication unit 5 described above.

In some embodiments, the printer station 101 can comprise an output device 104. The output device 104 can be configured, for example, to output a printed electronic paper 1. In some embodiments, it can be provided that the output device 104 can move and/or move the stack 103 in the direction of the provision location 107 during or after the printing of an electronic paper 1, in particular e.g. of an uppermost electronic paper 1 of the stack 103, and/or during or after a removal of the printed electronic paper 1. Thus, for example after the removal of a printed electronic paper 1, a further electronic paper 1 can be moved and/or moved to the provision location 107. The further electronic paper 1 can already be printed, but in some embodiments can also be unprinted and/or not yet printed. If the electronic paper 1 is unprinted and/or not yet printed at the provision location 107, it can be provided that electronic paper 1 is to be printed at the provision location 107.

In some embodiments, it can be provided that the virtual printer 3 and/or the printer unit 102 can supply and/or supply the electronic paper 1 with power before, during and/or after the printing, for example before, during and/or after the transmission of the data set and/or the displaying of the document. The supply with power can be carried out, for example, via NFC. Electronic paper 1, virtual printer 3 and/or printer unit 102 can be configured accordingly. It can thus be provided that the virtual paper 1 cannot and/or does not have its own power supply, for example does not have or does not have a battery and/or an accumulator. The electronic display 1 can be configured to consume power only when changing the displayed document 2 and/or when displaying a document 2 for the first time. It can be provided that the electronic display 1 does not consume power when it displays a document 2.

In some embodiments, it can be provided that an electronic paper 1 can be returned to the printer station 101 again after use, in order to be printed in or by the printer station 101 again. In some embodiments, the printer station 101 can have a suitable receptacle.

The features disclosed in the description, the figures and/or the claims can be essential individually or in any combination for implementing the invention.

What is claimed is:

1. A method for printing a document on an electronic paper with a virtual printer, the method comprising:
a) selecting a document to be printed;
b) creating a print job for printing the document to be printed;
c) creating, based on the print job, a data set representing the document to be printed in a format interpretable by the electronic paper with the virtual printer;
d) transmitting the data set to the electronic paper; and
e) displaying the document to be printed on the electronic paper based on the transmitted data set, so that the electronic paper is printed with the document to be printed by the virtual printer,
wherein preferably the print job comprises a page description language or a printer language.

2. The method according to claim 1, wherein the print job comprises a data format dvi, ps, pdf, xps, svg, and/or pcl.

3. The method according to claim 1, in which the virtual printer performs a dithering during and/or after the creation of the data set.

4. The method according to claim 1, in which the virtual printer substantially corresponds to a network printer and/or comprises a network printer, wherein preferably the print job is created by a peripheral device connected to the virtual printer for data exchange and is transmitted to the virtual printer.

5. The method according to claim 1, in which the data set is transmitted to a plurality of electronic papers during the transmission of the data set, and in which the document to be printed is displayed on each of the plurality of electronic papers during the display of the document to be printed.

6. The method according to claim 5, in which a separate print job and/or the data set is created for each of the plurality of electronic papers, and the document is transmitted in a format interpretable by the respective electronic paper during the transmission of the data set to a respective electronic paper.

7. The method according to claim 1, in which the document to be printed has a plurality of pages, wherein the electronic paper displays a page of the plurality of pages during the display of the document to be printed and changes the displayed page in response to a control command.

8. The method according to claim 1 wherein the document to be printed differs from a document already printed on the electronic paper during the selection of the document to be printed, so that the electronic paper is printed again.

9. A virtual printer system, comprising at least one electronic paper and at least one virtual printer, wherein the electronic paper is connected to the virtual printer for data exchange, and wherein the virtual printer is configured to print the electronic paper with a document to be printed using a method according to claim 1.

10. The virtual printer system according to claim 9, wherein the document to be printed is or comprises an accompanying slip, a ticket, a transport list or a sequence protocol.

11. The virtual printer system according to claim 1, wherein the electronic paper is connected to the virtual printer via narrowband IOT.

12. The virtual printer system according to claim 1, which comprises a plurality of virtual printers which are connected to the at least one electronic paper for data exchange.

13. The virtual printer system according to claim 1, which comprises at least one peripheral device, wherein the peripheral device is connected to the virtual printer for data exchange, wherein the peripheral device is configured to transmit a document to be printed and/or a print job to the virtual printer.

14. The virtual printer system according to claim 1, which comprises a printer station having a provision location for providing electronic paper, wherein the printer station comprises a printer unit for printing electronic paper provided at the provision location, wherein the printer unit is connected to the virtual printer for data exchange.

15. The virtual printer system according to claim 14, wherein at or at the provision location a plurality of electronic papers are stacked on top of one another to form a stack and the printer station is configured and/or arranged such that one or more electronic papers of the stack can be printed.
